(19) United States
(12) Patent Application Publication
(10) Pub. No.: US 2026/0073320 A1
(43) Pub. Date: Mar. 12, 2026

(54) ADAPTIVE GUIDELINE CUSTOMIZATION AND PROFILING FOR TAILORED ASSESSMENTS

(71) Applicant: Kyndryl, Inc., New York, NY (US)

(72) Inventors: Omar Odibat, Cedar Park, TX (US); Umar Mohamed Iyoob Umar, Manor, TX (US); Anil Babu Boppanna, Bangalore (IN)

(21) Appl. No.: 18/829,841

(22) Filed: Sep. 10, 2024

(51) Int. Cl. G06Q 10/0631; H04L 67/10; H04L 67/306

(52) U.S. Cl. CPC G06Q 10/063114; H04L 67/10; H04L 67/306

(57) ABSTRACT

A computer-implemented method includes: generating, by a computing device, a set of customized guidelines using at least user data and a current set of known guidelines; improving, by the computing device, the set of customized guidelines using a refined customer profile including user data of a current client; providing, by the computing device, a maturity assessment of the current client using the improved set of customized guidelines and known maturity assessments; and providing a recommendation to the current client based on the improved set of customized guidelines and maturity assessment.

### BACKGROUND

Aspects of the present invention relate generally to adaptive guideline customization and profiling for tailored assessments and, more particularly, to an adaptive guideline customization and profiling system, method and computer program product to provide tailored assessments of operational maturity in the usage of cloud resources.

FinOps is an operational framework and cultural practice which maximizes the business value of cloud resources, enables timely data-driven decision making and creates financial accountability through collaboration between engineering, finance and business teams. To maximize the benefits of FinOps, users, e.g., clients, perform manual assessments of their systems to determine how mature they are financially and operationally in the cloud landscape. To provide these assessments, detailed data of cloud usage and cost is required along with a clear understanding of the technologies being promoted within an organization. This process is repeated to make any necessary changes and to see how these changes will reflect in an overall maturity.

### SUMMARY

In a first aspect of the invention, there is a computer-implemented method including: generating, by a computing device, a set of customized guidelines using at least user data and a current set of known guidelines; improving, by the computing device, the set of customized guidelines using a refined customer profile comprising user data of a current client; providing, by the computing device, a maturity assessment of the current client using the improved set of customized guidelines and known maturity assessments; and providing a recommendation to the current client based on the improved set of customized guidelines and maturity assessment.

In another aspect of the invention, there is a computer program product including one or more computer readable storage media having program instructions collectively stored on the one or more computer readable storage media. The program instructions are executable to: generate a set of customized guidelines using training data with a large language model; improve the set of customized guidelines using a customer profile comprising user data of a current client; generate a maturity assessment of the current client using the improved set of customized guidelines and additional maturity assessments; and provide a recommendation to the current client based on the improved set of customized guidelines and the maturity assessment.

In another aspect of the invention, there is a system including a processor, a computer readable memory, one or more computer readable storage media, and program instructions collectively stored on the one or more computer readable storage media. The program instructions are executable to: generate a set of customized guidelines using a large language model; improve the set of customized guidelines using a customer profile comprising user data of a current client; generate a maturity assessment of the current client using the improved set of customized guidelines and stored maturity assessments of other entities; and provide a recommendation to the current client based on a combination of the improved set of customized guidelines and service provider recommendations.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows a block diagram of an exemplary environment in accordance with aspects of the invention.

FIG. 5 shows a flowchart of an exemplary training method in accordance with aspects of the invention.

FIG. 6 shows a flowchart of an exemplary method of providing maturity assessments in accordance with aspects of the invention.

FIG. 7 shows a flowchart of an exemplary method of providing recommendations in accordance with aspects of the invention.

### DETAILED DESCRIPTION

Aspects of the present invention relate generally to adaptive guideline customization and profiling for tailored assessments and, more particularly, to an adaptive guideline customization and profiling system, method and computer program product which provides tailored assessments of operational maturity for specific clients in their usage of cloud resources. More specifically, the present invention provides a system, method and computer program product to efficiently perform financial operations (FinOps) to maximize business value of cloud resources, enabling a timely data-driven decision making process by integrating the use of different, customized domains, categories, principles and management of FinOps practices for a particular client. In this way, it is now possible to dynamically provide a FinOps maturity assessment on the usage of cloud resources by generating a capability assessment with accompanying recommendations customized for a client. In this manner, the system, method and computer program product addresses challenges posed by FinOps.

In more specific embodiments, the system, method and computer program product provide a technical feature (e.g., technical solution) to a technical problem and a practical application of identifying and integrating different domains and capabilities, personas and other customized factors to provide recommendations for improving to FinOps practices. For example, the system, method and computer program product dynamically provide a FinOps maturity assessment of cloud resources and generates a capability assessment with recommendations for a client by using customized data. This can be accomplished, for example, by generating forecast models, projections and customized recommendations of cloud resources using, for example, machine learning (ML) techniques. The machine learning (ML) techniques may use historical data including, for example, knowledge about previous assessments by a same assessor and similar clients and other factors as described herein. For example, the machine learning (ML) may use guidelines based on, for example, historical data, industry metrics/key performance indicators (KPIs), a set of client data (e.g., metadata, communications, current infrastructure, etc.), and customized guidelines, e.g., FinOps guidelines. Accordingly, the system, method and computer program product provide a robust and reliable FinOps, which can identify current FinOps and provide recommendations for improvements to the FinOps, etc.

Hence, from a technical solution which provides a practical application, the system, method and computer program product provides an analytical platform with an ability to utilize any number of customizable and pertinent factors for a particular client to improve efficiencies in FinOps. In this way, the system, method and computer program overcome deficiencies in existing approaches in FinOps. By way of an example, existing approaches to FinOps are manual in nature and prone to mistakes, errors and/or oversights from the FinOps team, and require iterative processes that are very time consuming and intensive, and which may use data (e.g., FinOps guidelines) that are not applicable for a particular client. Also, illustratively, current FinOps practices use all of the same FinOps guidelines regardless of whether the client is in different industries, different regions for the same industry, has a different maturity level, etc. such that the guidelines become ineffective for providing accurate assessments and recommendations for improvement in the FinOps across different industries, regions, maturity levels, etc.

On the other hand, embodiments of the present invention combine expert knowledge and zero-shot, few-shot and hybrid assessments to refine cloud efficiency and cost optimization, which are key drivers in a market where businesses are increasingly focused on reducing cloud waste and enhancing agility. In addition, embodiments of the present invention provide assessments that not only align with financial regulations but will also offer strategic, data-backed recommendations to specific clients, aiding clients in informed cloud investment and usage decisions that is customized for their needs. The present invention uses these assessments, in combination with recommendations from service providers, to provide recommendations to the client.

It should be understood that, to the extent implementations of the invention collect, store, or employ personal information provided by, or obtained from, individuals (for example, during FinOps processes) such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium or media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:
On-demand self-service: a cloud consumer can unilaterally provision computing capabilities, such as server time and network storage, as needed automatically without requiring human interaction with the service's provider.
Broad network access: capabilities are available over a network and accessed through standard mechanisms that promote use by heterogeneous thin or thick client platforms (e.g., mobile phones, laptops, and PDAs).
Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).
Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:
Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.
Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.
Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:
Private cloud: the cloud infrastructure is operated solely for an organization. It may be managed by the organization or a third party and may exist on-premises or off-premises.
Community cloud: the cloud infrastructure is shared by several organizations and supports a specific community that has shared concerns (e.g., mission, security requirements, policy, and compliance considerations). It may be managed by the organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

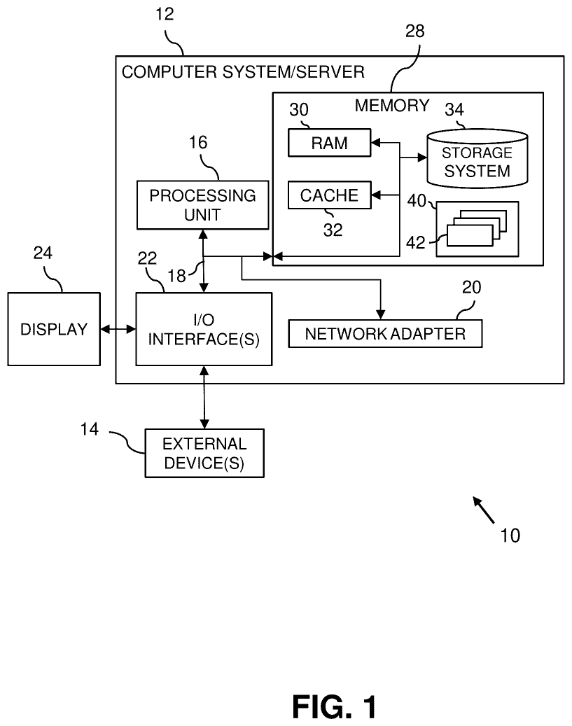

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc. ; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

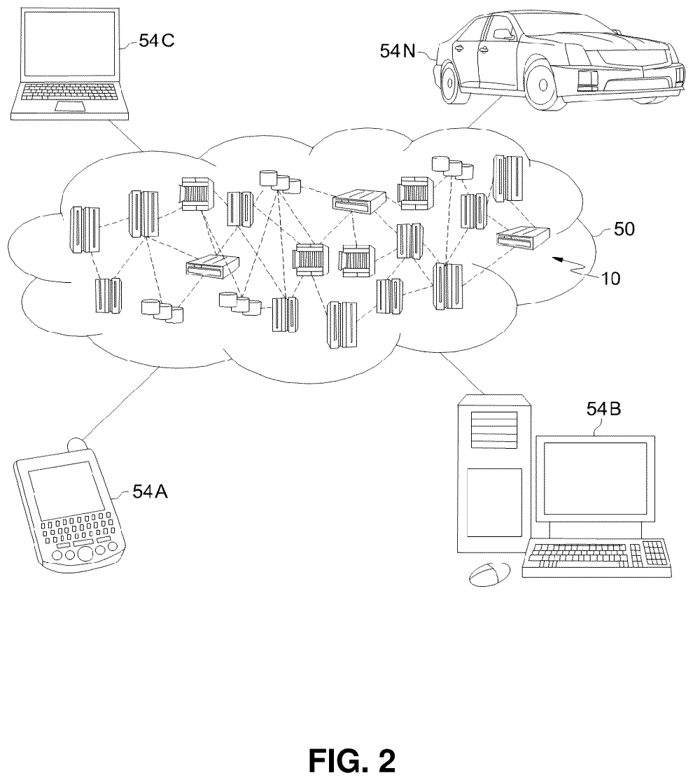

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

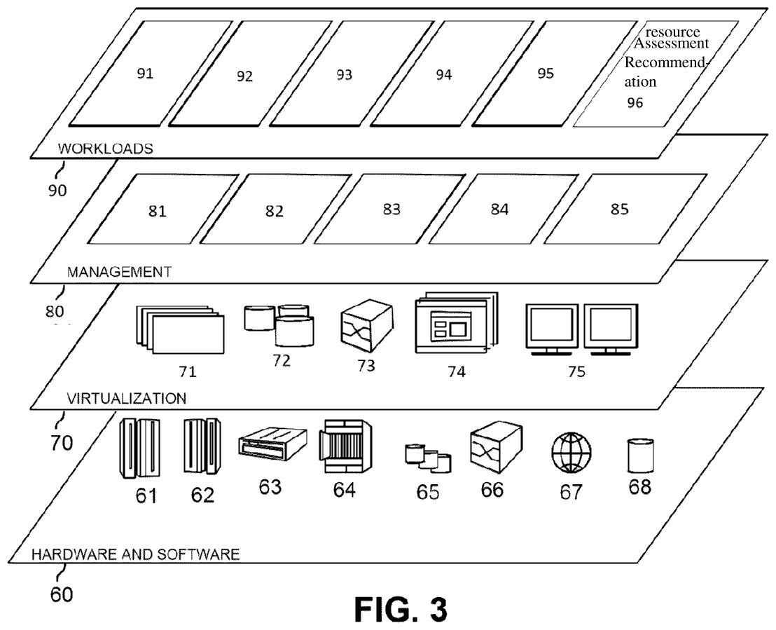

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and cloud resource assessment and recommendation 96.

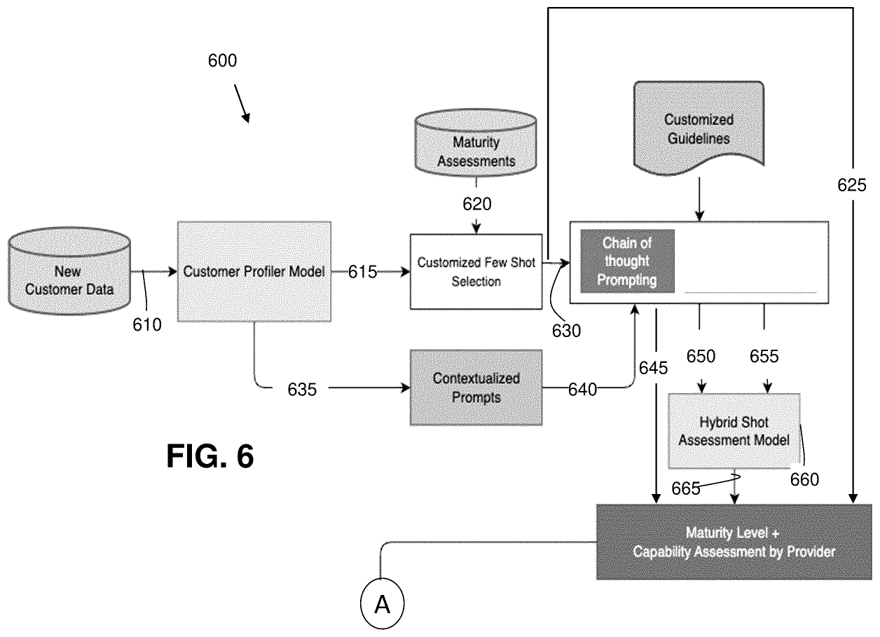

Implementations of the invention may include a computer system/server 12 of FIG. 1 in which one or more of the program modules 42 are configured to perform (or cause the computer system/server 12 to perform) one of more functions of the cloud resource assessment and recommendation 96 of FIG. 3. For example, the one or more of the program modules 42 may be configured to perform the cloud resource assessment and recommendation 96, including:
(i) use customized guidelines for maturity assessments. For example, the program modules 42, e.g., cloud resource assessment and recommendation 96, may use a guideline customization model that uses historical assessments and user data to provide customize guidelines for a client, e.g., industry peer, etc., which, in turn, can be used to refine and provide accurate maturity assessments;
(ii) provide maturity assessments and recommendations from large language models (LLM) and, in embodiments;
(iii) define contextualized prompts for new clients including, for example, using communication metadata related to specific needs of a client. This may be accomplished using, for example, a customer profiler model;
(iv) provide recommendations that are aligned with large cloud service providers (e.g., Hyperscalars) to align services with current and intended client cultures and needs. The services may be, for example, computing and storage at enterprise scale;
(v) provide level-up, strategic recommendations that align with client goals using, for example, a recommendation comprehension model (which may also take provider generated recommendations into consideration). For example, the program modules 42, e.g., cloud resource assessment and recommendation 96, improve cost saving optimization or management of data by providing recommendations to upgrade infrastructure. This may include, for example, combining expert knowledge and zero-shot, few-shot and hybrid assessments to refine cloud efficiency and cost optimization to reduce cloud waste and enhance agility in cloud resources (as described with respect to FIG. 6);
(vi) reinforce paths or course corrections in cloud resource usage by combining initial maturity recommendations along with, for example, provider-generated recommendations;
(vii) implement the use of machine learning (ML) techniques. For example, the machine learning (ML) may include large language models (LLMs), which are very large deep learning models pre-trained on vast amounts of data. The underlying transformer is a set of neural networks that comprise an encoder and a decoder with self-attention capabilities. The encoder and decoder, for example, extract meanings from a sequence of text and understand the relationships between words and phrases in the text; and
(viii) use multiple prompting approaches to obtain the best data from subject matter expert (SME) backed results.

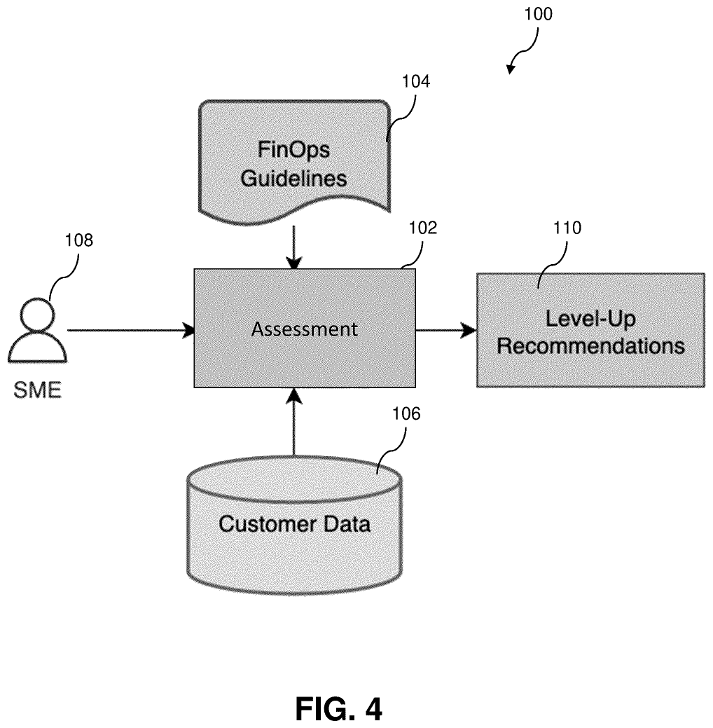

FIG. 4 shows a block diagram of an exemplary environment in accordance with aspects of the invention. In embodiments, the environment 100 includes an assessment module 102. The assessment module 102 may use FinOps guidelines 104, customized data 106 and data obtained by subject matter experts (SME) 108 to generate a maturity assessment, which is used to provide a level-up recommendation using the recommendation module 110. As should be understood by those of skill in the art, the recommendation module 110 will provide a recommendation to a client for optimizing cloud resources as described herein. It should be understood by those of skill in the art that the present invention is also applicable to other aspects of an organization, where other types of guidelines can be used, e.g., DevOps guidelines, etc. Thus, although this disclosure focuses on FinOps, it is understood that the present disclosure equally applies to other aspects and their respective guidelines. e.g., DevSecOp, MLOps, AlOps, NoOps, GreenOps, APIOps, CloudOps, DataOps, ModelOps, AppOps, XOps, AnyOps, etc.

In embodiments, the assessment module 102 and the recommendation module 110 may comprise one or more program modules such as program modules 42 described with respect to FIG. 1. The assessment module 102 and the recommendation module 110 may include additional or fewer modules than those shown in FIG. 4. In embodiments, the separate modules may be integrated into a single module. Additionally, or alternatively, a single module may be implemented as multiple modules. Moreover, the quantity of devices and/or networks in the environment is not limited to what is shown in FIG. 4. In practice, the environment may include additional devices and/or networks; fewer devices and/or networks; different devices and/or networks; or differently arranged devices and/or networks than illustrated in FIG. 4.

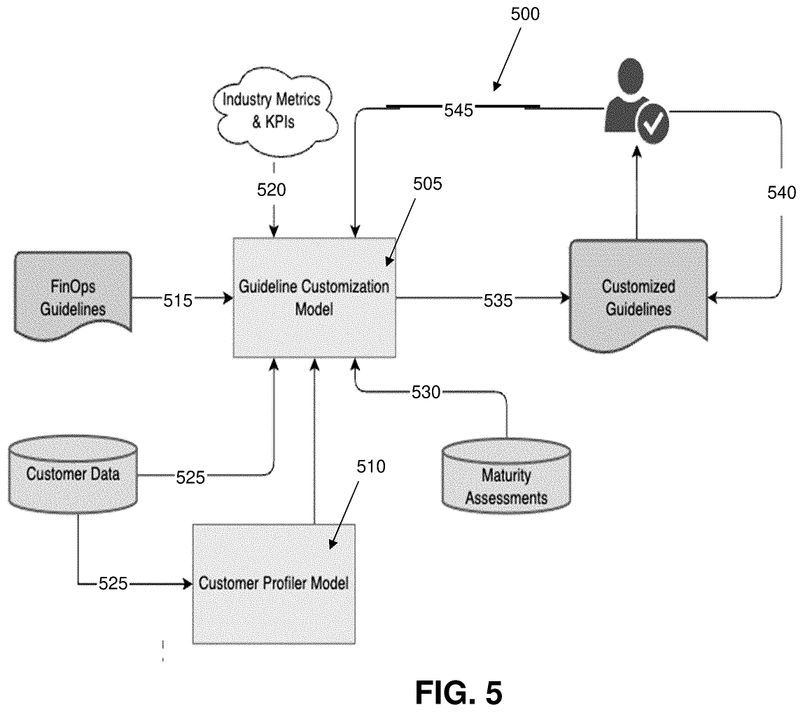

In embodiments, the assessment module 102 may use the FinOps guidelines (or framework) 104 to provide a maturity assessment. In more specific embodiments, the assessment module 102 may generate a set of unique guidelines from the FinOps guidelines (or framework) 104 to make assessments tailored to a specific client. As described in further detail with respect to FIG. 5, the assessment module 102 may generate the set of unique guidelines taking into consideration the unique maturity and needs of a client using a client profile, in combination with other relevant data. The customized guidelines may include any combination of the following, which is customizable for a particular client:
(i) understanding of cloud usage and costs as they related to data ingestion, allocation, reporting and analytics and anomaly management;
(ii) quantification of business value as it relates to planning and estimating, forecasting, budgeting, benchmarking and unit economics;
(iii) optimization of cloud usage and cost as it relates to architecture for the cloud, workload optimization, licensing and SaaS, rate optimization and cloud sustainability; and
(iv) management of the FinOps practices including, for example, FinOps practice operations, cloud policy & governance, FinOps assessment, FinOps tools and services, FinOps education and enablement, invoicing and chargeback, onboarding workloads and intersection disciplines.

The FinOps guidelines (or framework) 104 may additionally take into consideration any combination of core personas such as engineering, leadership, procurement, product, finance and FinOps practitioners, as well as allied personas including, for example, IT asset management (ITAM), IT financial management (ITFM), IT service management (ITSM), security and sustainability. In addition, the FinOps guidelines (or framework) 104 may include other information that is customizable for the client such as, for example:
(i) teams that need to collaborate;
(ii) decisions driven by business value of the cloud;
(iii) ownership for cloud usage;
(iv) FinOps data that needs to be accessible and timely;
(v) a centralized team that needs to drive FinOps; and
(vi) the variable cost model of the cloud, etc.

It should be recognized that any combination of these guidelines may be used depending on the particular client and their needs, compared to conventional systems which use all of these factors regardless of their applicability or pertinence for a particular client. For example, in embodiments, more mature clients (e.g., clients that already have a robust infrastructure) may use different guidelines than a less mature client (e.g., clients that have a less robust infrastructure).

The customer data may include any communications, metadata or other data that can be used to provide an initial assessment of maturity. The data may include, for example, current efficiencies or inefficiencies in cloud resources, the use of certain infrastructure related to cloud usage, etc. The customer data may also include historical assessments of the client, or data of similarly situated clients with similar infrastructure and/or within a similar industry, and/or industry peers, and/or within a similar region, etc. any of which may also be pertinent to the current client. In embodiments, it should also be recognized that the guidelines can be customized for a specific client based on the customer data retrieved from the client using prompts. As described in more detail herein, this may be done through a customer profiler model that uses machine learning (ML) to understand which kind of profile this customer belongs to and based on that profile, identify which guidelines should or should not be used from the list of guidelines described herein. These customized guidelines and the SME 106 may be used to generate a maturity assessment from the assessment module 102, and with the maturity assessment generate a recommendation from the recommendation module 110.

FIG. 5 shows a flowchart 500 of an exemplary method in accordance with aspects of the present invention. Steps of the method may be carried out in the environment of FIG. 4 and are described with reference to elements depicted in FIG. 4. In particular, the flowchart of FIG. 5 shows a process to customize guidelines for a particular client. These processes may be considered a training phase to obtain a set of customized guidelines to be used for future generation of maturity assessments and recommendations. As described with respect to FIG. 5, the goal of the process flow is to change the rules and/or variables in the rules, e.g., thresholds, to fit the needs for an individual client. In other words, the goal of the processes of FIG. 5 is to provide a set of unique guidelines for each client. This may include, for example, using a set of previously optimized SME guidelines and feedback, industry metrics and Key Performance Indicators (KPIs), as well as customized standards and practices and customer profiles. In this way, it will be possible to provide base guidelines that FinOps can apply to a particular client.

It should also be understood that the many steps provided in FIG. 5 may be representative of program modules 42 that carry out the functions and/or methodologies of embodiments of the invention as described herein. For example, the guideline customized model 505 and the customer profile model 510 may be representative of program modules 42 that carry out the functions and/or methodologies of embodiments of the invention as described herein. The guideline customized model 505 and the customer profile model 510 may use machine learning (ML) techniques, and more specifically, large language models (LLMs), to provide customized guidelines.

Referring to FIG. 5, at step 515, FinOps guidelines are fed into a guideline customized model 505. Similarly, at step 520, industry metrics and KPIs are fed into guideline customized model 505. It should be understood that KPIs are critical (key) quantifiable indicators of progress toward an intended result. KPIs provide a focus for strategic and operational improvement, create an analytical basis for decision making and help focus attention on what matters for the client. Moreover, at step 525, customer (e.g., client) data is fed into both the guideline customized model 505 and the customer profile model 510.

In embodiments, the customer data may be already obtained customer data that is stored in a database, e.g., storage system of FIG. 1. The customer data may be from a variety of different customers in different regions, different industries, different demographics, different cloud resources and infrastructure, different cultures and needs, etc. The customer data may include, for example, cloud usage data, client communications, meeting transcripts and delivery notes used to generate culture related features, and other information that may be pertinent to evaluating the needs of a client for FinOps as described herein. Additional information may include, for example, demographic information, industry type, sales and revenue, projections or forecasts (e.g., sales at particular time of year, type of items, etc.), and other information that may be used to improve the accuracy of the maturity assessment. Further information may include client details and metadata including services, subscriptions, industry, revenue, cloud management and other factors. As further described with respect to FIG. 6, the customer profile model 510 may be used to ‘select’ few-shots to be sent along with the requests for an LLM for the assessment. The same context may not be applicable to clients from different sectors, for example, hence may not be used to make peer comparisons.

In addition, at step 530, previous maturity assessments may be fed into the guideline customized model 505. The previous maturity assessments may also be held in a database, e.g., storage system of FIG. 1. The previous maturity assessments may be associated with a current client being analyzed for FinOps and/or other clients or organizations that may have a similar need for FinOps, e.g., infrastructure, size, industry, region, etc. The maturity assessments should not be limited to the assessments noted above and may include assessments of a host of other organization, whether previously analyzed or obtained from public knowledge. In embodiments, the maturity assessments may be public data from FinOps or other organizations, as an example.

In embodiments, the customer profile model 510 may use generative AI such as, for example, LLMs, to determine a particular profile for the client based on the obtained customer data. This profile may be a category such as, for example, current maturity of the client, e.g., “crawl”, “walk” or “run”. Other categories may include, for example: (i) type of client; (ii) type of industry; (iii) organizational culture; (iv) demographic information, etc. in further embodiments, categories can be defined by the SME. By having an SME provide categories, it is now possible to have an initial clustering or initial assignment for AI or LLM training purposes, as an example. In any scenario, these categories can be used to compare against other organizations, whether they be peers or have other similarities. The profile may also be used for a model that generates client centric prompts for both assessment and development needs.

It should be understood by those of ordinary skill in the art that FinOps may categorize organization into “crawl”, “walk” or “run”. For example, an organization categorized as “crawl” may be immature with little reporting and tooling and basic processes and policies defined around their current capabilities, e.g., infrastructure. The FinOps team would typically try to address the basic needs for such an organization, compared to an organization that is categorized as “run”. An organization categorized as “run”. On the other hand, would be a more mature organization with a well defined infrastructure and cloud resources. The recommendation for such an organization would be to, for example, increase efficiency, decrease costs, and optimize the infrastructure through more automated approaches.

The guideline customized model 505 may also use generative AI such as, for example, LLMs, to determine which guidelines, from the list of guidelines, may be applicable for the client, based on the customer (e.g., client) profile and other information obtained at steps 515, 520, 525 and 530. Accordingly, using the information obtained in each of the different steps, it is now possible to customize the guidelines to meet the needs and which are particularly applicable for a particular client. This is very helpful in that the customized guidelines, which are generated at step 535, are directed to the current situation of the client. That is, there is no longer a need to provide a manual process which uses each and every guideline, which is prone to mistakes, errors and/or oversights, nor applicable to a particular client such as, for example, providing guidelines to a client that is in a particular industry, e.g., banking, which are otherwise applicable in another industry, e.g., manufacturing. This allows the maturity assessment to be more accurate and allows it to be done in a more efficient manner, for example.

At step 540, a subject matter expert (SME) may review the customized guidelines. The SME may determine that the customized guidelines are adequate or, alternatively, at step 545, the SME may determine that the customized guidelines are not adequate and may need additional customization. As to the latter, the customized guidelines may be fed back into the guideline customized model 505 for further refinement, in an iterative process.

FIG. 6 shows a flowchart 600 of an exemplary method in accordance with aspects of the present invention. Steps of the method may be carried out in the environment of FIG. 4 and are described with reference to elements depicted in FIG. 4. In particular, the flowchart of FIG. 6 shows a process to provide maturity assessments for a particular client using the customized guidelines generated in FIG. 5. As described with respect to FIG. 6, the goal of the process flow is to provide a zero-shot prompt generated assessment based purely on its understanding of the FinOps guidelines and pre-trained knowledge, in addition to provide a few-shot prompt generated assessment based on the examples provided along with FinOps guidelines. In embodiments, the zero and few-shot assessments are not same as they assess cloud maturity in different perspectives based on its knowledge by using the examples provided. Moreover, the processes of FIG. 6 may provide a hybrid shot model using both assessments as inputs and generating a more refined assessment to thus capture maximum variance of the cloud maturity. In this way, it will be possible to provide customized and more accurate maturity assessments for a particular client.

It should also be understood that the many steps provided in FIG. 6 may also be representative of program modules 42 that carry out the functions and/or methodologies of embodiments of the invention as described herein. For example, the hybrid shot assessment model 605 and the customer profile model 510 may be representative of program modules 42 that carry out the functions and/or methodologies of embodiments of the invention as described herein. The hybrid shot assessment model 605 and the customer profile model 510 may use machine learning (ML) techniques, and more specifically, large language models (LLMs), to generate the maturity assessments.

Referring to FIG. 6, at step 610, new customer data may be fed into the customer profile model 510, which is used to generate a profile of a new client, similar to the processes as described with respect to FIG. 5. In this way, the customer profile model 510 may be used to further refine and/or define the profile for the current client, with the previously entered data used in FIG. 5 being the training data.

At step 615, the output of the customer profile model 510 is fed into a customized few-shot selection. Additionally, in embodiments, at step 620, the maturity assessments as described in FIG. 5 are fed into the customized few-shot selection. In embodiments, the maturity assessments fed from step 620 may be the maturity assessments first generated at step 535 of FIG. 5 that closely match to the client profile as output at step 610 from the custom profile model. The customized few-shot selection will select the customized guidelines based on the client profile and maturity assessments. If there is an exact match between the profile of the client and there is already a maturity assessment that matches to such a client profile, the process may proceed at step 625, in which the final output of maturity level and capability assessment for the maturity level may be provided.

If there are no maturity assessment that matches to the client profile or the client profile does not match to any other client profiles and, hence, there is not related maturity assessment, the processes will continue at step 630 to a chain of thought prompt. Also, at step 635, the customer profile model 510 may output customer (e.g., client) prompts to be provided as conceptualized prompts to the client. The prompts (e.g., client provided information) are also fed to the chain of thought prompts at step 640. In embodiments, the conceptualized prompts may be customized problems for different clients including, for example, responses related to a default, skill, or revenue and managed service provider (MSP)/partner. For example, and as a non-limiting feature, the following prompts may be provided for different clients based on the client profile:
(i) Default: Conduct a precise FinOps maturity evaluation—Crawl, Walk, or Run—of this client, grounded in their cloud financial operations;
(ii) Skill: Assess a highly experienced client's FinOps maturity with stringent criteria. Details provided should lead to a strict evaluation of advanced financial operations practices, and only the most sophisticated levels of optimization and governance should qualify as Run;
(iii) Revenue: Analyze a high-revenue client's FinOps maturity, taking into account their financial context. Cost savings may be less critical due to their scale, so focus the assessment on cultural shifts towards FinOps principles rather than immediate cost reduction strategies; and
(iv) MSP/partner: Evaluate a cloud partner's FinOps maturity, focusing on cost allocation methods rather than utilization rates or discounts. Their culture around cloud cost is not well-formed as they provide resources to others. Highlight how they allocate costs and manage clients using their services.

In embodiments, the output of steps 630 and 640 may be fed to the chain of thought, where additional information may be requested from the client. This additional information may be used to further define the client profile and/or other information related to an already generated maturity assessment or an already generated set of customizable guidelines which may be applicable to the current client. For example, the information may be an assessment that similar industries may be related to the client and, hence, already generated customizable guidelines related to the similar industry may be applied to the current client for maturity assessment analysis. In this scenario, the processes can continue at step 645 directly to the final output of maturity level and capability assessment for the maturity level may be provided.

In the case that no matches are found or inadequate matches are found, the processes will continue to steps 650 and 655. Steps 650 and 655 may be provided by an LLM to determine a maturity assessment based on the client profile, the set of customizable guidelines, and conceptualized prompt, etc. For example, at step 650, a zero-shot assessment generates an assessment based purely on its understanding of the customized FinOps guidelines and pre-trained knowledge; whereas, at step 655, a few-shot assessment generates an assessment based on the examples provided along with FinOps guidelines. In other words, the zero-shot assessment learns without any example or context and the few-shot assessment learns with examples and context. Accordingly, the zero-shot assessment and few-shot assessment are not same as they assess cloud maturity in different perspectives based on its knowledge by using or not using provided examples.

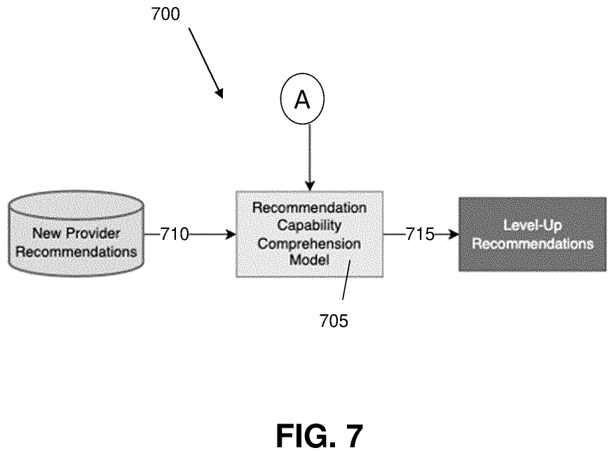

Moreover, the processes of FIG. 6 may provide a hybrid shot model using both assessments as inputs and generating a more refined maturity assessment using a hybrid shot assessment model 660. In embodiments, the hybrid shot assessment model 660 may be a subset of a maturity assessment model. Also, in embodiments, the hybrid shot assessment model 660 may also be a LLM which captures a maximum variance of the cloud maturity using the the zero-shot assessment and the few-shot assessment. In this way, it will be possible to provide customized and more accurate maturity assessments for a particular client as output from the hybrid shot assessment model 660 at step 665. The maturity assessment may proceed to be used in the flow of FIG. 7 to generate a recommendation.

In a non-limiting example, the zero-shot assessment may be:
Capability: Rate Optimization
Maturity: Crawl
Assessment: The client has a large number of assets and unique asset types, indicating a complex cloud infrastructure. Lack of budget data suggests that cost allocation practices are not fully developed or integrated.

In a non-limiting example, the few-shot assessment may be:
Capability: Rate Optimization
Maturity: Crawl
Assessment: Given the scale of assets, there's a missed opportunity in optimizing spend and implementing unit economics. The absence of budget total, budget spend, and budget threshold data points towards a lack of governance and cost management practices.

In a non-limiting example, the hybrid shot assessment may be:
Capability: Rate Optimization
Maturity: Crawl
Assessment: The client's cloud infrastructure exhibits complexity, evident from the large number of assets and diverse asset types. However, the absence of comprehensive budget data, including budget total, budget spend, and budget threshold, indicates a gap in governance and cost management practices. This lack of visibility into spending limits the ability to optimize expenditure and implement efficient unit economics.

It should be noted that the maturity assessments may be fed back into the process flows of either FIG. 5 or FIG. 6 to further refine the models, e.g., maturity assessments in the database can be refed into guideline customization model 505 or the customized few-shot selection. In this way, the processes herein and, more particularly, the set of customizable guidelines for particular profiles and maturity assessments can be refined in an iterative feed-back loop process.

FIG. 7 shows a flowchart 700 of an exemplary method in accordance with aspects of the present invention. Steps of the method may be carried out in the environment of FIG. 4 and are described with reference to elements depicted in FIG. 4. In particular, the flowchart of FIG. 7 shows a process to provide recommendations based on maturity assessments generated in FIG. 6. It should also be understood that the steps provided in FIG. 7 may also be representative of program modules 42 that carry out the functions and/or methodologies of embodiments of the invention as described herein. For example, the recommendation capability and comprehension model 705 may be representative of program modules 42 that carry out the functions and/or methodologies of embodiments of the invention as described herein. The recommendation capability and comprehension model 705 may use machine learning (ML) techniques, and more specifically, large language models (LLMs), to provide customized recommendations.

At step 705, provider recommendations are provided to the recommendation capability and comprehension model 705. In addition, at step 710, the maturity assessments from the process flow of FIG. 6 are fed into the recommendation capability and comprehension model 705. In embodiments, the provider recommendations may be stored in a database, e.g., storage system 34. The provider recommendations may be, for example, a recommendation that the client needs to buy x-number of reservations to save money on regular pricing for virtual machines, as an example. Other recommendations may also be provided based on a maturity level of the client. The provider recommendations in combination with the maturity assessment provided from the flow of FIG. 6 can be used by the recommendation capability and comprehension model 705 to provide a final recommendation from a different perspective of the service provider. For example, the recommendation capability and comprehension model 705 may provide a recommendation based on the set of customized guidelines, the maturity assessment which were generated using the set of customized guidelines and other factors described herein, in addition to the service provider recommendations. These recommendations may be, for example, financial recommendations, infrastructure recommendations, cloud resource utilization, and/or organizational recommendations, amongst others.

By way of example, the provider recommendations may be, for example, a recommendation that the client needs to buy x-number of reservations to save money on regular pricing for virtual machines, as an example. In addition, a hybrid assessment response may be:
Capability: Rate Optimization
Maturity: Crawl
Assessment: The existing reservations have been purchased by multiple teams with siloed budgets. Coverage rates are very low and are not a material financial impact to the business.

Taking into consideration these factors, the recommendation capability and comprehension model 705 may provide the following recommendations: “Your maturity is not going to increase significantly by purchasing reservations at this current time. Focus on aligning teams with existing reservations to coordinate settings with Finance, Procurement and FinOps teams. Centralized analysis should then be performed prior to any new purchases.” Accordingly, the recommendation capability and comprehension model 705 will take provider generated recommendations into consideration while delivering assessment backed level-up recommendations, in addition to the results from the hybrid shot assessment model 660 of FIG. 6. In alterative or additional embodiments, the recommendation capability and comprehension model 705 may take into use any combination of the one-shot assessment, the few-shot assessment or the final assessment provided at steps 645 and 665 when providing the final recommendation.

Accordingly, by implementing the processes of the present invention, it is now possible to provide recommendations that are aligned with large cloud service providers (e.g., Hyperscalars) with current and intended client cultures and needs. It should also be recognized that embodiments of the invention further contemplate providing notice to a service provider or organization that made the assessment and recommendation when the recommendations are not being met. In this way, additional assessments and, if needed, alternative recommendations may be made to the client using the processes described herein.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system/server 12 (FIG. 1), can be provided and one or more systems for performing the processes of the invention can be obtained (e.g., created, purchased, used, modified, etc.) and deployed to the computer infrastructure. To this extent, the deployment of a system can comprises one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
generating, by a computing device, a set of customized guidelines using at least user data and a current set of known guidelines;
improving, by the computing device, the set of customized guidelines using a refined customer profile comprising user data of a current client;
providing, by the computing device, a maturity assessment of the current client using the improved set of customized guidelines and known maturity assessments; and
providing a recommendation to the current client based on the improved set of customized guidelines and maturity assessment.

2. The method of claim 1, wherein the set of customized guidelines are customized FinOps guidelines generated using at least one of customer data, known maturity assessments and industry metrics and key performance indicators and subject matter experts.

3. The method of claim 2, wherein the improved set of customized FinOps guidelines are customized for the current client.

4. The method of claim 1, further comprising generating customized prompts using the user data of the current client of the refined customer profile, and using answers of the customized prompts to customize the guidelines for the current client.

5. The method of claim 1, wherein the maturity assessment of the current client uses the improved set of customized guidelines and known maturity assessments.

6. The method of claim 1, wherein the maturity assessment of the current client comprises a zero-shot assessment comprising training data and the improved set of customized guidelines, without context or examples.

7. The method of claim 1, wherein the maturity assessment of the current client includes a few-shot assessment comprising examples and the set of improved customized guidelines.

8. The method of claim 1, wherein the maturity assessment of the current client comprises a hybrid assessment that comprises zero-shot assessment and a few-shot assessment.

9. The method of claim 1, wherein the recommendation to the current client is based on a recommendation of a service provider.

10. The method of claim 1, wherein the providing the maturity assessment uses a large language model.

11. The method of claim 1, wherein the generating the set of customized guidelines uses training data on a large language model, the training data comprising client profiles and the current set of known guidelines.

12. The method of claim 1, wherein the computing device includes software provided as a service in a cloud environment.

13. A computer program product comprising one or more computer readable storage media having program instructions collectively stored on the one or more computer readable storage media, the program instructions executable to:
generate a set of customized guidelines using training data with a large language model;
improve the set of customized guidelines using a customer profile comprising user data of a current client;
generate a maturity assessment of the current client using the improved set of customized guidelines and additional maturity assessments; and
provide a recommendation to the current client based on the improved set of customized guidelines and the maturity assessment.

14. The computer program product of claim 13, wherein the training data comprises at least one of data from a group of users, a set of known guidelines, known maturity assessments, industry metrics and key performance indicators and subject matter experts.

15. The computer program product of claim 13, wherein the set of customized guidelines are customized FinOps guidelines.

16. The computer program product of claim 13, wherein the improved set of customized guidelines are customized for the current client using at least one of customized prompts and additional user data of the current client.

17. The computer program product of claim 13, wherein the maturity assessment of the current client comprises a zero-shot assessment comprising training data and the improved set of customized guidelines, without context or examples, and a few-shot assessment comprising examples and the set of improved customized guidelines.

18. The computer program product of claim 17, wherein recommendation to the current client is generated using a service provider recommendation and the maturity assessment.

19. A system comprising:
a processor, a computer readable memory, one or more computer readable storage media, and program instructions collectively stored on the one or more computer readable storage media, the program instructions executable to:
generate a set of customized guidelines using a large language model;
improve the set of customized guidelines using a customer profile comprising user data of a current client;
generate a maturity assessment of the current client using the improved set of customized guidelines and stored maturity assessments of other entities; and
provide a recommendation to the current client based on a combination of the improved set of customized guidelines and service provider recommendations.

20. The system of claim 19, wherein the large language model uses training data to generate the set of customized guidelines, the training data comprises at least one of data from a group of users, a set of known guidelines, known maturity assessments, industry metrics and key performance indicators and subject matter experts.
